(19) United States
(12) Patent Application Publication
(10) Pub. No.: US 2024/0177166 A1
(43) Pub. Date: May 30, 2024

(54) PROFILING-BASED DETECTION FOR BLOCKCHAINS

(71) Applicant: Ancilia, Inc., Los Gatos, CA (US)

(72) Inventors: Huagang Xie, Los Gatos, CA (US); Wei Xu, Cupertino, CA (US)

(21) Appl. No.: 18/522,033

(22) Filed: Nov. 28, 2023

Related U.S. Application Data
(60) Provisional application No. 63/429,036, filed on Nov. 30, 2022.

(51) Int. Cl. G06Q 20/40; G06Q 20/38

(52) U.S. Cl. CPC G06Q 20/4016; G06Q 20/389

(57) ABSTRACT

Techniques for profiling-based detection for blockchains are disclosed. In some embodiments, a system/process/computer program product for profiling-based detection for blockchains includes monitoring a transaction on a blockchain; detecting an anomaly associated with the transaction using the profiling-based detection platform; and performing an action in response to detecting the anomaly associated with the transaction.

### CROSS REFERENCE TO OTHER APPLICATIONS

This application claims priority to U.S. Provisional Patent Application No. 63/429,036 entitled PROFILING-BASED DETECTION FOR BLOCKCHAINS filed Nov. 30, 2022 which is incorporated herein by reference for all purposes.

### BACKGROUND OF THE INVENTION

A blockchain generally refers to a growing list of records called blocks. Blockchains are typically managed using a peer-to-peer network that can be used as a publicly distributed ledger. The nodes of the peer-to-peer network collectively adhere to a protocol to communicate and to validate new blocks.

The blocks of a blockchain are generally linked together using cryptography. Each block typically contains a cryptographic hash of the previous block, a timestamp, and associated transaction data (e.g., typically implemented as a tree, such as a Merkle tree, in which data nodes are represented by leaves). The timestamp can be used to prove that the transaction data existed when the block was published to get into its hash.

As blocks each contain information about the previous block, they form a chain. Each additional block generally reinforces the previous blocks in the chain. As such, blockchains are typically resistant to modification of their data, because once recorded, the data in any given block cannot be altered retroactively without altering all subsequent blocks (e.g., however, forks can occur in a chain).

### BRIEF DESCRIPTION OF THE DRAWINGS

Various embodiments of the invention are disclosed in the following detailed description and the accompanying drawings.

FIG. 1 is a block diagram of an architecture of a threat prevention platform for security detection for blockchains in accordance with some embodiments.

FIG. 2 is another block diagram of an architecture of a threat prevention platform for security detection for blockchains in accordance with some embodiments.

FIG. 3A is pseudocode of an example workflow for an API service for security detection for blockchains in accordance with some embodiments.

FIG. 3B is pseudocode for an integration into Smart Contract source code in accordance with some embodiments.

FIG. 3C is pseudocode for a customer setup detection policy (via a Dashboard) in accordance with some embodiments.

FIG. 3D is pseudocode for the Detector to perform an action based on a blockchain security detection policy in accordance with some embodiments.

FIG. 4 is a flow diagram of a process for security detection for blockchains in accordance with some embodiments.

FIG. 5 is another flow diagram of a process for security detection for blockchains in accordance with some embodiments.

FIG. 6 is a block diagram of an architecture of a profiling-based detection platform for security detection for blockchains in accordance with some embodiments.

FIG. 7 is a flow diagram of a process for profiling-based detection for blockchains in accordance with some embodiments.

FIG. 8 is another flow diagram of a process for profiling-based detection for blockchains in accordance with some embodiments.

FIGS. 9A-C illustrate an example use case for performing profiling-based detection for blockchains can be used to detect Non-Fungible Token (NFT) phishing related activities based on automatically detecting abnormal behaviors in accordance with some embodiments.

FIG. 10 illustrates an example use case for performing profiling-based detection for blockchains to detect the Omni hack in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A blockchain generally refers to a growing list of records called blocks. Blockchains are typically managed using a peer-to-peer network that can be used as a publicly distributed ledger. The nodes of the peer-to-peer network collectively adhere to a protocol to communicate and to validate new blocks.

The blocks of a blockchain are generally linked together using cryptography. Each block typically contains a cryptographic hash of the previous block, a timestamp, and associated transaction data (e.g., typically implemented as a tree, such as a Merkle tree, in which data nodes are represented by leaves). The timestamp can be used to prove that the transaction data existed when the block was published to get into its hash.

As blocks each contain information about the previous block, they form a chain. Each additional block generally reinforces the previous blocks in the chain. As such, blockchains are typically resistant to modification of their data, because once recorded, the data in any given block cannot be altered retroactively without altering all subsequent blocks (e.g., however, forks can occur in a chain).

### Overview of Techniques for Security Detection for Blockchains

However, technical security challenges with blockchains exist.

For example, solutions are needed for automatically detecting threats on block chains (e.g., including transactions on the blocks to, for example, enhance security for smart contracts).

Existing security solutions are inadequate and are generally focused on pen testing/security audits of the programming code for different blockchain implementations.

Moreover, current smart contract (SC) protection largely depends on manual code analysis, also known as auditing, the goal of which is to identify vulnerabilities in smart contract code before deployment and fixing any identified issues in the smart contract code. However, this has primarily been a manual effort. As a result, such existing approaches are inadequate for several reasons, including, for example, the following: (1) it is not scalable; and (2) the quality of the audit work is typically not consistent, as such largely depends on the experience of the human analyzer.

There are existing tools that can facilitate the process of manual code analysis, including fuzzing tools, SAT tools, etc. These tools can facilitate some aspects of the analysis, such as identifying known vulnerability patterns in a smart contract. However, these tools generally cannot increase the protection capability provided by the manual code analysis approach.

As such, what are needed are new and improved security techniques for security detection for blockchains.

Accordingly, new and improved security techniques for security detection and profiling-based detection for blockchains are disclosed.

In some embodiments, a system/process/computer program product for security detection in blockchains includes monitoring a plurality of transactions (e.g., smart contract transactions) on a blockchain; generating a risk score for each of the plurality of transactions; and sending an alert if a risk score for at least one of the plurality of transactions is below a threshold (e.g., based on a blockchain security policy).

In one embodiment, a system/process/computer program product for security detection for blockchains further includes detecting a malicious transaction on the blockchain.

In one embodiment, a system/process/computer program product for security detection for blockchains further includes detecting a malicious transaction on the blockchain based on a signature match.

In one embodiment, a system/process/computer program product for security detection for blockchains further includes detecting a malicious transaction on the blockchain based on a heuristic match.

In one embodiment, a system/process/computer program product for security detection for blockchains further includes detecting a malicious transaction on the blockchain based on a machine learning (ML) model.

In one embodiment, a system/process/computer program product for security detection for blockchains further includes generating an alert for a smart contract transaction based on the risk score for the smart contract transaction and a blockchain security policy.

In one embodiment, a system/process/computer program product for security detection for blockchains further includes reverting a smart contract transaction based on a score for the smart contract transaction and a blockchain security policy.

For example, the disclosed techniques include providing a profiling-based detection platform for blockchains as will be further described below with respect to various embodiments.

In an example implementation, a profiling-based detection platform for blockchains provides runtime security protection for blockchains. Specifically, we can understand and extract expected behavior of a given smart contract. More specifically, we can generate a machine learning (ML) model that can automatically map a given smart contract to a set of expected behaviors (e.g., using clustering or other machine learning techniques (MLT), such as will be further described below). As more smart contract's expected behavior is analyzed and understood (manually), the ML model for smart contract behavior will increase in accuracy and coverage over time.

In this example implementation, we can apply the expected behaviors in a runtime detection system using the profiling-based detection platform (e.g., in the form of a smart contract (SC) profile that can be programmatically provided as input to the runtime detection system) that will compare any transaction (Tx) against the expected behaviors and identify any suspicious/malicious Tx. Any runtime-identified deviations from an SC's expected behavior can also be provided back into the ML model for smart contract behavior (e.g., and, in some cases, manual analysis can also be performed) to further improve the accuracy of the ML model for smart contract behavior.

For example, the disclosed techniques for security detection for blockchains can be implemented to automatically monitor smart contracts for a QUBIT Blockchain® (e.g., and/or other publicly/commercially available blockchains). In this example, the ML model for smart contract behavior can be trained for all interactions with their smart contracts for the QUBIT Blockchain® to learn normal behaviors/interactions with their smart contracts to generate/train the ML model for smart contract behavior to learn expected input to such contracts. The generated/trained ML model for smart contract behavior can then be deployed in the profiling-based detection platform for blockchains to automatically detect anomalous behavior associated with smart contracts for the QUBIT Blockchain®. In addition, heuristics can also be implemented in the profiling-based detection platform for blockchains to further enhance security detection for blockchains based on such smart contract transactions (e.g., input anomaly detection in terms of size, form, or increase in interaction with these functions, as well as the result after interaction with this function, which typically succeeds or fails repeatedly; or outcome/output is different than expected for typical input such as a drain of coin pool, etc.).

The disclosed techniques for security detection for blockchains can be deployed using various distinct customer consumption models. For example, the disclosed techniques for security detection for blockchains can be deployed as a service, such as a subscription service model. As another example, the disclosed techniques for security detection for blockchains can be deployed as an API service, such as an API service that provides reputation of a given entity (e.g., an entity associated with a potential smart contract transaction, in which an entity type can include an Address (EOA/Contract), Tx (KYT), etc.). These services can provide, for example, a risk score associated with a given transaction and/or entity, scoring contextual information, score change notifications, etc.

### Overview of Techniques for Profiling-Based Detection for Blockchains

Further, existing approaches for detection (e.g., signatures, pattern matching, etc.) can detect “known” hacks. However, such existing approaches based on detection of known hacks are generally not capable or effective at automatically detecting “unknown” hacks (e.g., zero day threats or other hacks that have not been previously identified). Moreover, given the fast evolution of the blockchain stack and decentralized applications' on the blockchain (Dapps) logic, many hacks exhibit previously unknown behaviors.

As such, solutions are needed for automatically profiling threats on block chains (e.g., including transactions on the blocks to, for example, enhance security for smart contracts).

In some embodiments, a system/process/computer program product for profiling-based detection in blockchains includes monitoring a transaction on a blockchain; detecting an anomaly associated with the transaction using the profiling-based detection platform; and performing an action in response to detecting the anomaly associated with the transaction.

For example, the disclosed techniques for profiling-based detection in blockchains include automatically detecting unknown hacks by profiling the behavior of the entities on the blockchain. Specifically, the disclosed techniques for profiling-based detection in blockchains include learning the normal or expected behaviors over time (e.g., for determining a baseline behavior for the blockchain) and then applying such for automatically detecting abnormal or unexpected behaviors (e.g., relative to a threshold difference from the baseline behavior for the blockchain), such as further described below.

In one embodiment, a system/process/computer program product for security detection for blockchains further includes generating a profile for an address.

In one embodiment, a system/process/computer program product for security detection for blockchains further includes updating a profile for an address.

In one embodiment, a system/process/computer program product for profiling-based detection for blockchains further includes detecting an anomalous transaction on the blockchain based on a profile.

These and other embodiments and examples for security detection and profiling-based detection for blockchains will be further described below.

### Example System Architectures for Security Detection and Profiling-Based Detection for Blockchains

Accordingly, in some embodiments, the disclosed techniques include providing a security detection for blockchains as will now be further described with respect to various system embodiments.

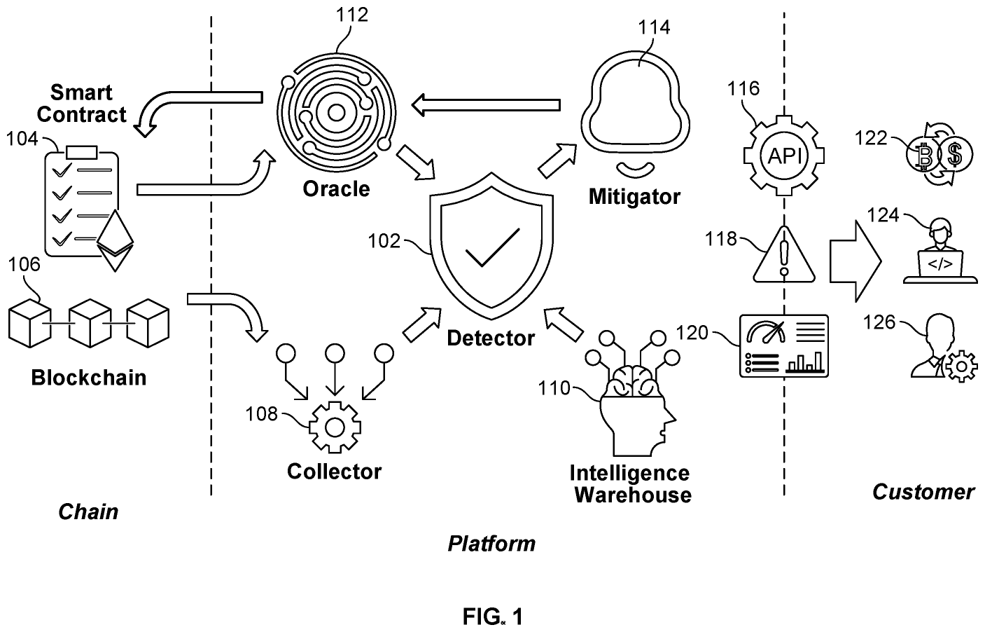

FIG. 1 is a block diagram of an architecture of a profiling-based detection platform for security detection for blockchains in accordance with some embodiments. While the disclosed profiling-based detection platform for security detection for blockchains can be applied to various implementations of blockchain technology (e.g., Bitcoin, Ethereum, QUBIT Blockchain®, and/or other publicly/commercially available blockchains), the below described embodiment is described in the context of an Ethereum blockchain implementation.

Referring to FIG. 1, a Smart Contract 104 is in communication with an Oracle service 112. The Smart Contract(s) are for transactions for a Blockchain 106. The profiling-based detection platform includes a Detector component 102, a Collector component 108, an Intelligence Warehouse component 110, a Mitigator component 114, and customer/user-facing component(s) that can include an API service component 116, an Alerting service component 118, and a user interface (e.g., a Dashboard that can be implemented as a graphical user interface (GUI)) 120 for interactions/communications with users/entities as shown at 122, 124, and 126 in FIG. 1. Each of these components will be further described below.

### Oracle Service

The Oracle service provides an immediate-read Oracle for this example Blockchain. Specifically, the Oracle service provides info from off-chain (e.g., by storing such information in the Oracle contract's storage). An example mapping for such storage is illustrated below.
Info 1: mapping(addr=>uint)addr_scores;
Info 2: mapping(addr=>user_policy)user_policy;

The Oracle service can also include an updater service. Specifically, the updater service can update the Oracle contract's storage with latest Info[1,2] as shown above.

The Detector is in communication with the Oracle service. In an example implementation, the Detector can communicate with the Oracle service using a Request-response Oracle service (e.g., blockchain Dapps can utilize the Request-response Oracle, the response to which would be another Tx).

### Collector

The Collector collects data from on-chain/offchain of the Blockchain.

In an example implementation, the following is example input data for the Collector: an API URL; an API KEY; a monitored contract address; a coin address; and/or a price Oracle address.

In this example implementation, the following is example data that is collected by the Collector: Ethereum block data, and transaction; Ethereum block balance of a monitored address for a different Coin (e.g., WETH, WBTC, etc.); Ethereum internal transactions; and/or an Ethereum internal call trace.

In an example implementation, output data from the Collector can be added to a queue and fed into a data store.

### Detector

The Detector calculates a risk score for Blockchain addresses.

In an example implementation, the following is example input data for the Detector: (1) from the Blockchain: Tx, Trace, logs (by the Collector); (2) from the Internet: address intelligence (from the Intelligence Warehouse); and (3) from research/automated learning: patterns (or models).

In this example implementation, the Detector includes a Detection Engine. The Detection Engine loads (and translates) patterns into an internal data structure (DS). The Detection Engine applies all loaded patterns on a Tx (e.g., as the Tx is being broadcast to the network). When a matching pattern is detected, the Detection Engine then updates the risk score of the address in the Tx.

In an example implementation, the following is example input data for the Detector: (1) calculated risk score of addresses (and store score in DB); and (2) the risk score is pushed to the Oracle service. For immediate Oracle access, the address to risk score mapping can be updated on the Oracle's storage. For a request-response Oracle access: Oracle service can query the risk score datastore/database.

An example input data structure for the detector component (e.g., detection engine), which contains all of the information about one block that is stored on the blockchain, is provided below.

```
{′number′: 2000000,
‘hash’: ‘0xc38853328f753c455edaa4dfc6f62a435e05061beac136c13dbdcd0ff38e5f40’,
‘timestamp’: 1470173578,
‘transactions’: [
  {‘from’: ‘0xA1E4380A3B1f749673E270229993eE55F35663b4’,
  ‘to’: ‘0x5DF9B87991262F6BA471F09758CDE1c0FC1De734’,
  ‘input’: 0x,
  ‘gas’: 21000,
  ‘maxFeePerGas’: 20000000,
  ‘maxPriorityFeePerGas’: 1000000000,
  ‘nonce’: 3,
  ‘value’: 31337,
  ‘logs’: [
    { ‘address’: ‘0xf4877805568f5c9a8600048ef198bff99fb01971’,
      ′data′:
′0x0000000000000000000000000000000000000000000539e22b0080250ac5e1e3000000000000
0000000000000000000000000000000052041d8db717cfad0ad0′,
      ′log_index′: ′2′,
      ′topico′:
′0x1c411e9a96e071241c2f21f7726b17ae89e3cab4c78be50e062b03a9fffbbad1′,
      ′topic1′: None,
      ′topic2′: None,
      ′topic3′: None,
        ......
    },
    ......
    ]
  },
  ......
  ]
......
}
      An example of output (e.g., an alert) for the detector component (e.g., detection
engine) is provided below:
{
      “txhash”:
“0x958236266991bc3fe3b77feaacea120f172c0708ad01c7a715b255f218f9313c”,
      “addr”: “0x7b792e49f640676b3706d666075e903b3a4deec6”,
      “blocknumber”: 14972419,
      “type”: “tornado funded flashloan”
}
```

The following is an example of patterns to match for risks by the detection engine. This particular pattern contains two events (e.g., that happen in sequence). Event A: an address received tokens from a ‘mixer” service (e.g., the purpose of this service is to hide the token transfer trails, which would otherwise be visible to everyone). Event B: the same address did a ‘flashloan,’ which is a type of loan (e.g., with no collateral) that the borrowing and repaying actions must be finished within the same transaction.

The following are example transactions that would be deemed high risk. The transactions are all about this address: 0x7b792E49f640676B3706d666075E903B3A4deEc6.
1. In transaction (0x84eelce4dd2aa5113aa7191baaea5f77ac85f6c95cba16135e89b11c272817e5), addr: 0x7b79 received 0.975623 Ether from tornado.cash service.
2. In transaction (0xfb5a4dlaef98458f673f301c2e713613662ad621e8f57065a4da58a6401c0b4d), addr 0x7b79 created a new contract (0xf508c58ce37ce40a40997c715075172691f92e2d) using the Ether previously received from tornado.cash service.
3. In transaction (0x958236266991bc3fe3b77feaacea120f172c0708ad01c7a715b255f218f9313c), addr 0x7b79 interacts with the newly created contract (0xf508) to launch a flashloan that manipulated a certain token price. After doing so, addr 0x7b79 leverages the price change to gain $1.26M.

These transactions are a real-world hack example causing a Defi project greater than a $5M loss.

### Intelligence Warehouse

The Intelligence Warehouse includes a Crawler that can crawl feeds (e.g., Twitter, forums, blogs, such as a Twitter example available at https://twitter.com/peckshield/status/1537383268844072960?ref_src=twsrc%5Etfw%7Ctwcamp%5Etweetembed%7Ctwterm%5E1537383268844072960%7Ctwgr%5E%7Ctwcon%5Es1_&ref_url=https%3A%2F%2Fwww.inverse.finance%2Fblog%2Fpreview%2Fposts%2Fen-US%2Fjune-16-incident-summary%3FpreviewKey%3Dlorem-ipsum, and a blog example available at https://rekt.news/leaderboard/, etc.) for any information related to the Blockchain address (address).

The Intelligence Warehouse includes an Analyzer that can extract an address (e.g., Blockchain address and related labels from the crawled content), which can then be stored in an Intel datastore/database (DB). Example Labels can include the following: a hack association, a purpose of the address, owner of the address, etc.

### Customer-Facing Components

The customer/user-facing component(s) can include an API service component 116 (e.g., implemented as a RESTful API(s)), an Alerting service component (e.g., for generating alerts to users/subscribing entities, such as an alert of a potential transaction with an address that is below a threshold score and/or real-time (RT) alerts on detected/prevented Tx), and a user interface (e.g., a Dashboard that can be implemented as a graphical user interface (GUI)) for interactions/communications with users/entities. As an example, the customer/user-facing components can include a user interface (UI) that facilitates a user being able to configure a Blockchain security detection policy (e.g., risk thresholds, alerting triggers, etc.). As another example, the customer/user-facing components can include a user interface (UI) that facilitates a user being able to provide feedback on detection results (or any annotation).

Another example of a UI is that customers can review the overall security posture of their blockchain project (e.g., all the smart contracts deployed on the blockchain). This posture includes all the (risky) transactions that have interacted with their smart contract and the risk score associated with each transaction.

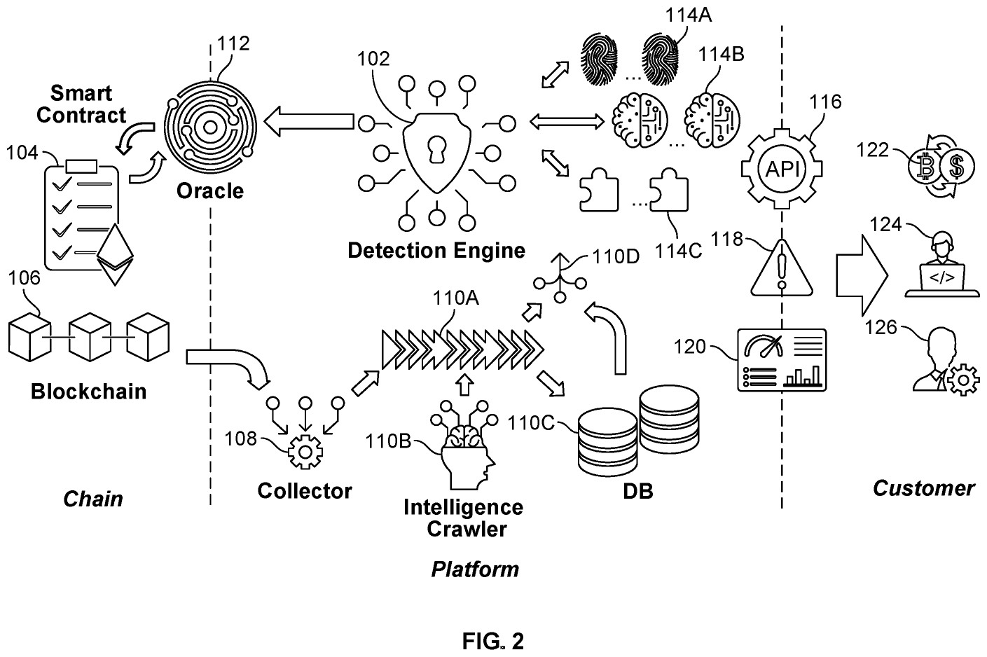

FIG. 2 is another block diagram of an architecture of a profiling-based detection platform for security detection for blockchains in accordance with some embodiments. FIG. 2 provides more detailed components for the above-described profiling-based detection platform.

Referring to FIG. 2, the Collector fetches information about the following: a transaction (Tx), trace, logs from the Blockchain as the Tx happens. The fetched information (e.g., from the Collector as shown at 108 and/or the Intelligence Crawler as shown at 110B, which can include an intelligence datastore/DB, such as a Mongo DB or another form of datastore/DB) is provided to a message bus as shown at 110A. The fetched information is then stored in a datastore/database (e.g., SQL database or another form of datastore/DB for storing the fetched information) as shown at 110C (e.g., DB 110C can also include a datastore/DB for storing Tx information, such as an SQL database or another form of datastore/DB). A data aggregator is shown at 110D, which aggregates the on-chain information as well as off-chain info, and sends the aggregated information to different detection modules in Detection Engine 102.

As also shown in FIG. 2, Detection Engine 102 can use signatures 114A for detecting malicious/suspicious transactions and/or malicious/suspicious entities associated with the transaction(s).

Signatures are generated by extracting unique information from known malicious activities. As an example, a signature can be a regex pattern matching a specific malicious Transaction Input data. When a signature is matched, a similar malicious transaction is detected.

The Detection Engine can also use ML models 114B for detecting malicious/suspicious transactions and/or malicious/suspicious entities associated with the transaction(s). For example, the ML model for smart contract behavior can be trained for all interactions with their smart contracts for the Ethereum Blockchain to learn normal behaviors/interactions with their smart contracts to generate/train the ML model for smart contract behavior to learn expected input to such contracts. The generated/trained ML model for smart contract behavior can then be deployed in the profiling-based detection platform for blockchains to automatically detect anomalous behavior associated with smart contracts for the Ethereum Blockchain.

The Detection Engine can also use heuristics 114C for detecting malicious/suspicious transactions and/or malicious/suspicious entities associated with the transaction(s). For example, heuristics can be implemented in the profiling-based detection platform for blockchains to further enhance security detection for blockchains based on such smart contract transactions (e.g., input anomaly detection in terms of size, form, or increase in interaction with these functions, as well as the result after interaction with this function, which typically succeeds or fails repeatedly; or outcome/output is different than expected for typical input such as a drain of coin pool, etc.).

Heuristics are generated based on analysis of smart contracts and known security issues/events. As an example, heuristics can be generated by extracting key patterns from malicious/suspicious activities (e.g., including known hacks) on the Blockchain. As another example, heuristics can be generated by extracting known/expected behaviors/functionalities of smart contracts.

The following are examples of the heuristics rules. Each rule describes and detects a specific combination of events (w/ or w/o sequence).

```
100000001″ : {
    ″title″ : ″Torando Hacks ″,
    ″description″ : ″ this alert detected the lifi hacks″,
    ″severity″: ″critical″,
    ″confidence″: ″high″,
      ″correlation″ : {
      ″key″ : ″addr″,
      ″signal″ : [
        {
          ″equal″ : {
              ″event″ : ″13″
            },
        ″match″ : {
              ″provider″ : ″aave″ ,
            ″borrower″ :
″0x78c94b6510fe5d2034c024e981fe5454a5c1e2d6″
            },
        ″greater″ : {″amount″ : ″10000″},
          ″count″ : ″2″
        },
        {
        ″match″ : {
              ″borrower″ :
″0x78c94b6510fe5d2034c024e981fe5454a5c1e2d6″
            },
        ″equal″ : {
            ″event″ : ″7″
            }
        },
      { ″match″ : {
          ″token″ : ″WETH”
          },
      ″equal″ : {
          ″event″ : ″122″
        }
        }
      ]
    },
″300000001″ : {
    ″title″ : ″Tornado $$ + Flashloan″,
    ″description″ : ″The detected addresses that receive $$ from tornado.cash, then do
flashloan″,
    ″unit-testing″ : {
      ″block″: [ ]
      },
    ″severity″: ″critical″,
    ″confidence″: ″high″,
      ″correlation″ : {
      ″key″ : ″addr″,
      ″signal″ : [
        {
        ″equal″ : {
            ″event″ : ″101″
              },
        ″greater″ : { ″amount″ : ″8″ }
        },
        {
        ″equal″ : {
              ″event″ : ″112″
            },
          ″match″ : {
            ″type″ : ″receive″
          }
      }
      ]
    },
}
```

As will now be apparent to one of ordinary skill in the art, the above-described profiling-based detection platform for security detection for blockchains can facilitate detection/prevention of security for blockchains as a service (e.g., as a subscription service).

In addition, the above-described techniques can similarly be deployed via an integration with Smart Contract (SC) source code to detect/prevent high risk transactions (Tx). For example, such an integration can support user annotation on expected behavior of the given SC.

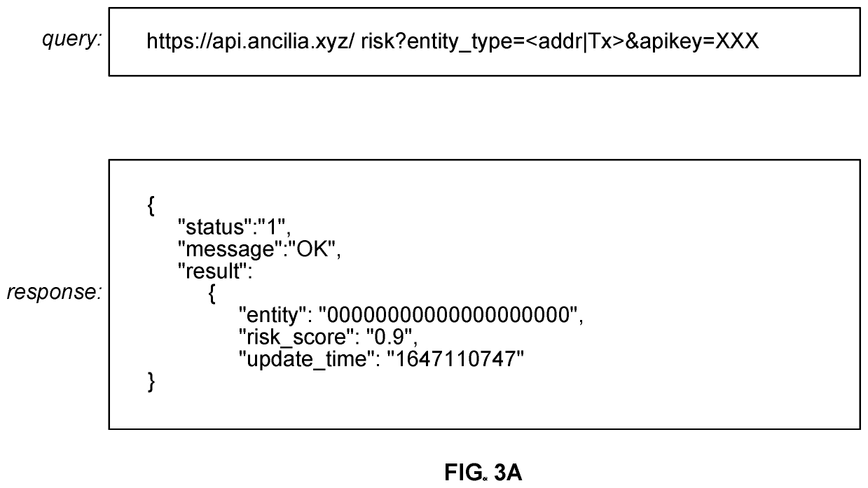

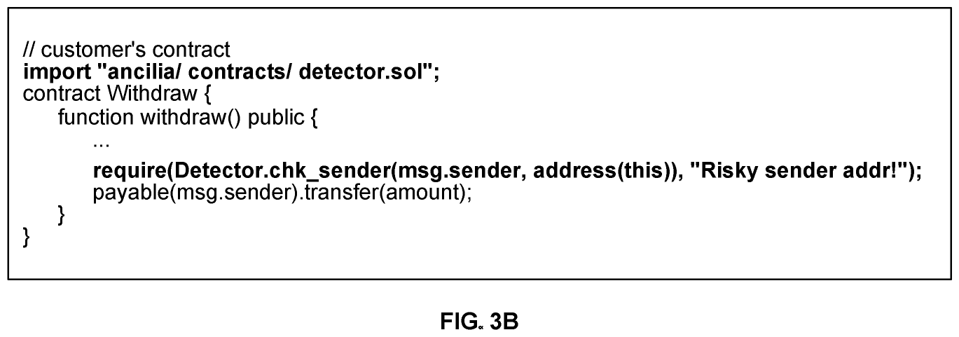

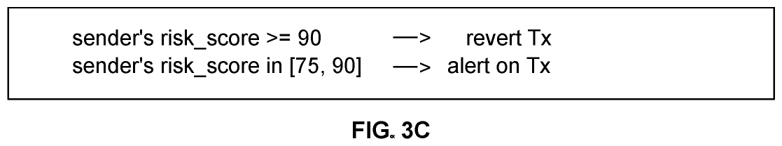

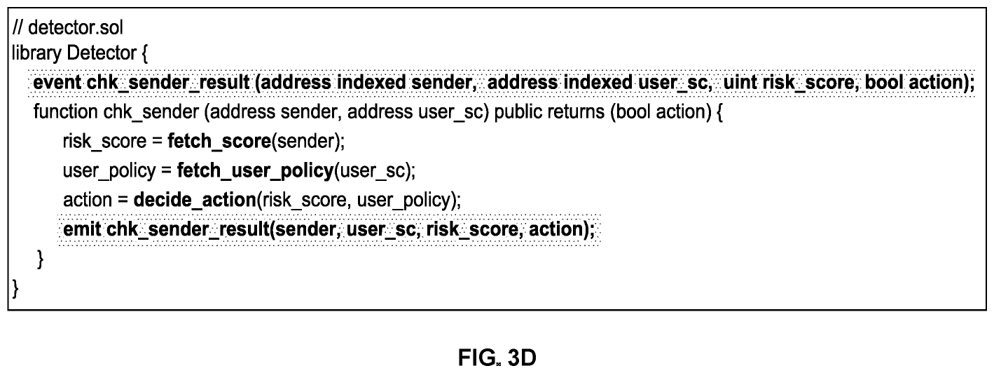

FIG. 3A is pseudocode of an example workflow for an API service for security detection for blockchains in accordance with some embodiments. Specifically, FIG. 3A is pseudocode of a standard workflow for the API service in JSON.

FIG. 3B is pseudocode for an integration into Smart Contract source code in accordance with some embodiments. For example, integration into a customer's Smart Contract source code (e.g., by the developer) can be implemented using various options. First, the Smart Contract can be programmed to import a library (lib) and perform a check in a critical function to call our Oracle contract (e.g., an Oracle contract associated with the profiling-based detection platform for security detection on blockchains). Second, the Smart Contract can be programmed to call a function (func) modifier, which can be applied on critical funcs, which calls our Oracle contract before the function is executed.

FIG. 3C is pseudocode for a customer setup detection policy (via a Dashboard) in accordance with some embodiments. As shown in this example Blockchain security detection policy for a given customer, if a sender's risk score exceeds a threshold of 90, then the profiling-based detection platform is configured to revert/allow the transaction (Tx). However, if a sender's risk score is below 90 but exceeds a threshold of 75, then the profiling-based detection platform is configured to alert on the transaction (Tx).

FIG. 3D is pseudocode for the Detector to perform an action based on a Blockchain security detection policy in accordance with some embodiments. In this example, the Detector will emit events, such as an event (Tx_sender, contract, risk_score, action), in which the “action” is based on a user defined policy, such as similarly described above. In an example implementation of a profiling-based detection platform for security detection for Blockchains, our client can listen and collect these events, and send to our platform, which will be presented to customers using the above-described customer-facing components.

As will now be apparent, blockchain transactions can be monitored/filtered using one or more security platforms to facilitate security detection for blockchains.

### Example Use Cases of Enhanced Security for Blockchains

The disclosed techniques for providing enhanced security for blockchains can be applied in a variety of additional example use case scenarios for facilitating security detection for blockchains as will now be described with respect to various example use cases.

As a first example use case, the disclosed techniques can be used to facilitate security detection for blockchains for the following example smart contract:

The following smart contract (“0x939bd8d64c0a9583a7dcea9933f7b21697ab6396”) which is a timelock that can execute transactions submitted from an admin account in a delayed fashion.

Part of the expected behavior of this smart contract is changing the admin address. This is a privileged operation and, hence, must be first initiated by the current admin who proposed a pending admin address, then accepted by the pending admin. The entire process requires two transactions (Tx) in that order.

With this understanding of the expected behavior, our system (e.g., threat prevention platform as described above) encountered the following Tx From “0xeaeb31370e9bbc912dlde71bf59bba89886fcfcb” to the SC (“0x939b”) at https://www.bscscan.com/tx/0xf4cb2df56b438ffb190b367014ca877cfbefbc0dad6e32cde9c0e9ea dd9dc97d, which is trying to invoke the following function on the SC (“0x939b”) (i.e., “Function: acceptAdmin( ) MethodID: 0x0e18b681).

The disclosed techniques for security detection of blockchains can identify this as an abnormal transaction (Tx), because there was no prior proposal from the current admin address to change admin to the “0xeaeb” address.

As another example use case, the disclosed techniques for security detection for blockchains can be used to detect the abnormal behaviors caused by smart contract's vulnerabilities. This example smart contract (0x20E5E35ba29dC3B540alaee781D0814D5c77Bce6) has a function “depositETH,” which uses an internal parameter “ResourceID.” “ResourceID” was originally set to the value of “0x2f422fe9ea622049d6f73f81a906b9b8cff03b7f01”. During a code upgrade, developers made a mistake and updated the “ResourceID” from its original value to “0x0”.

As a result of the mistake in an upgrade, when a transaction invoked the “deposit” function of the smart contract (0x20E5E35ba29dC3B540alaee781D0814D5c77Bce6), the transaction will only emit one “deposit” log. As a comparison, before the upgrade (i.e., code is correct), when a transaction invoked the “deposit” function, it will emit two logs: a “transfer” log and a “deposit” log.

The disclosed threat prevention platform for providing security detection for blockchains (e.g., our system) continuously monitors the transactions with the smart contract (0x20E5E35ba29dC3B540alaee781D0814D5c77Bce6) and learns the expected output of invoking the “deposit” function should include two logs (“transfer” and “deposit” respectively). With this learning, when our system encounters the first transaction (https://etherscan.io/tx/0x5af141b2c19cc8cb77a5583654575a6811664ebc304b75e687a6e356b7d d7cf7) that invoked the “deposit” function after the upgrade, our system can identify the anomaly and send alerts to the blockchain project team. As a result, the blockchain project team will have a chance to fix their prior mistake.

As will now be apparent to one of ordinary skill in the art, the disclosed techniques for security detection for blockchains using a security platform for security policy enforcement can be applied in a variety of additional example use case scenarios to detect/prevent these and other types of attacks for facilitating enhanced security for blockchains.

Additional example processes for the disclosed techniques for security detection for blockchains will now be described.

### Example Processes for Security Detection for Blockchains

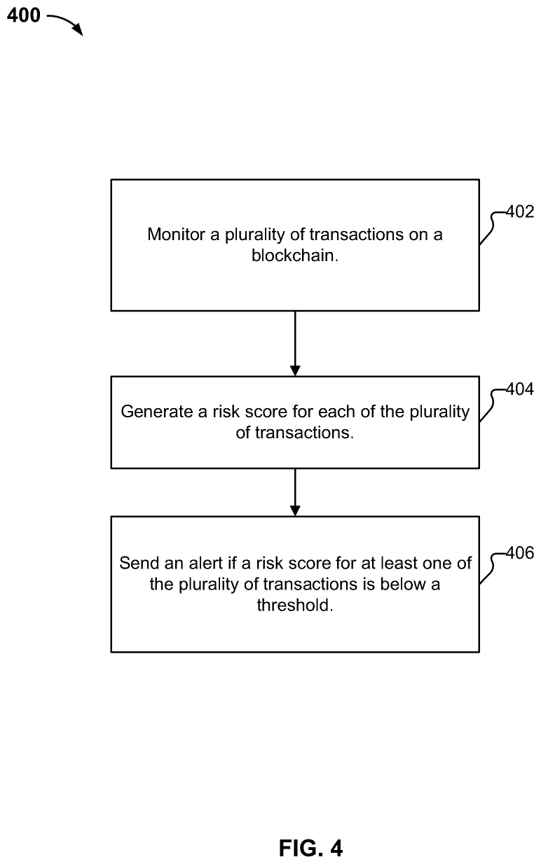

FIG. 4 is a flow diagram of a process for security detection for blockchains in accordance with some embodiments. In some embodiments, a process 400 as shown in FIG. 4 is performed by the security platform and techniques as similarly described above including the embodiments described above with respect to FIGS. 1-3D.

At 402, monitoring a plurality of transactions on a blockchain is performed. For example, the threat prevention platform for providing security detection for blockchains as similarly described above with respect to FIGS. 1-3D can be used for monitoring the plurality of transactions on the blockchain.

At 404, generating a risk score for each of the plurality of transactions is performed. For example, the Detection Engine component of the threat prevention platform for providing security detection for blockchains as similarly described above with respect to FIGS. 1-3D can be used for generating the risk score for each of the plurality of transactions. As also similarly described above, the risk score can be based on a signature, a heuristic, and/or an ML model that is trained for detecting risky/malicious transactions on the blockchain project.

At 406, an alert is sent if a risk score for at least one of the plurality of transactions is below a threshold. For example, the UI/alerting component of the threat prevention platform for providing security detection for blockchains as similarly described above with respect to FIGS. 1-3D can be used for sending the alert if the risk score for at least one of the plurality of transactions is below the threshold.

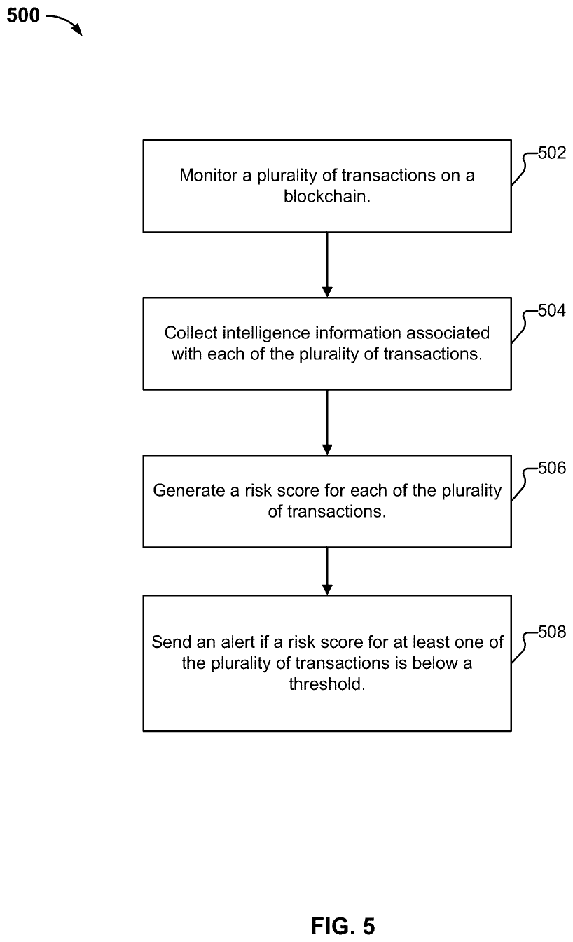

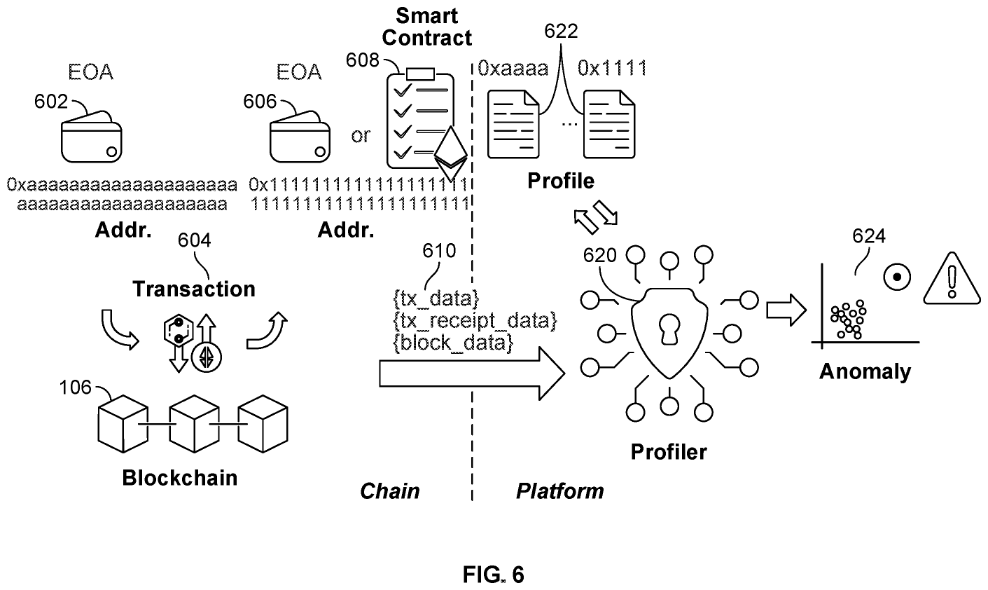

FIG. 5 is another flow diagram of a process for security detection for blockchains in accordance with some embodiments. In some embodiments, a process 500 as shown in FIG. 5 is performed by the security platform and techniques as similarly described above including the embodiments described above with respect to FIGS. 1-3D.

At 502, monitoring a plurality of transactions on a blockchain is performed. For example, the threat prevention platform for providing security detection for blockchains as similarly described above with respect to FIGS. 1-3D can be used for monitoring the plurality of transactions on the blockchain.

At 504, intelligence information associated with each of the plurality of transactions is collected. For example, the Collector and Intelligence Crawler components of the threat prevention platform for providing security detection for blockchains as similarly described above with respect to FIGS. 1-3D can be used for collecting intelligence information associated with each of the plurality of transactions.

At 506, generating a risk score for each of the plurality of transactions is performed. For example, the Detection Engine component of the threat prevention platform for providing security detection for blockchains as similarly described above with respect to FIGS. 1-3D can be used for generating the risk score for each of the plurality of transactions. As also similarly described above, the risk score can be based on a signature, a heuristic, and/or an ML model that is trained for detecting risky/malicious transactions on the blockchain project.

At 508, an alert is sent if a risk score for at least one of the plurality of transactions is below a threshold. For example, the UI/alerting component of the threat prevention platform for providing security detection for blockchains as similarly described above with respect to FIGS. 1-3D can be used for sending the alert if the risk score for at least one of the plurality of transactions is below the threshold.

### Example System Architectures for Security Detection and Profiling-Based Detection for Blockchains

Accordingly, in some embodiments, the disclosed techniques include providing a security detection for blockchain as will now be further described with respect to various system embodiments.

For example, the disclosed techniques for profiling-based detection in blockchains include automatically detecting unknown hacks by profiling the behavior of the entities on the blockchain. Specifically, the disclosed techniques for profiling-based detection in blockchains include learning the normal or expected behaviors over time (e.g., for determining a baseline behavior for the blockchain) and then applying such for automatically detecting abnormal or unexpected behaviors (e.g., relative to a threshold difference from the baseline behavior for the blockchain), such as will now be further described below with respect to FIG. 6.

FIG. 6 is a block diagram of an architecture of a profiling-based detection platform for security detection for blockchains in accordance with some embodiments. Referring to FIG. 6, an Externally Owned Account (EOA) 602 (e.g., a source address) performs a transaction 604 associated with another EOA 606 or a Smart Contract 608 on Blockchain 106. The profiling-based detection platform can monitor various data (e.g., meta data) associated with the transaction, such as shown at 610, and as will be further described below. A profiler component 620 monitors blockchain activities 622 (including transactions) to determine baseline/normal behaviors associated with the blockchain activities, such as will be further described below. The profiling-based detection platform can then compare various data (e.g., meta data) associated with the transaction 610 to the baseline/normal behaviors associated with the blockchain activities using the profiler 620 to detect an anomaly as shown at 624. In this example implementation, profiler 620 builds one or more statistical models based on behaviors of a target from various features including, for example, numerical, relational, temporal, and/or various other features that can be similarly used to generate one or more statistical models. For example, profiler 620 can also implement machine learning techniques (MLT) for applying/using the various features, such as numerical, relational, temporal, and/or various other features. In response to detecting the anomaly, the profiling-based detection platform can perform an action, such as generating an alert, blocking the transaction, blocking the EOA associated with the anomaly, blocking/reverting the Smart Contract associated with the anomaly, and/or another action/response can be performed in response to the anomaly detection.

Monitoring entities associated with the blockchain include, for example, (1) addresses, and (2) transactions (Tx) (e.g., other entities associated with the blockchain can also be monitored).

Referring to addresses (addr) (e.g., 20 to 40 bytes, such as a 40-byte stream), two types of addresses associated with the blockchain generally include (1) addresses for an Externally Owned Account (EOA); and (2) a Contract (e.g., unlike an EOA, a Contract can be associated with code for execution of certain logic and/or provide interfaces for other addresses to call). A contract can include a generic purpose contract, a token contract (e.g., for the minting, ownership, and/or transfer of different types of tokens), or a market contract (e.g., for a swap that allows users to exchange one cryptocurrency for another without leaving their blockchain wallet). Other special types of contracts can also exist and be similarly specified by an address.

Transactions (Tx) generally refer to interactions between addresses. Example transactions include (1) external Tx, and (2) internal Tx (e.g., function calls that are performed within each external Tx).

In an example implementation, monitored Behaviors on/associated with the blockchain are described in terms of different properties (e.g., mathematically, in many cases), such as will now be further described. Determining baselines for monitored behaviors can be used to detect suspicious or malicious activities associated with the blockchain.

A Numerical property can be used to specify a Statistic distribution and/or a Range (e.g., closed, one-sided). One example is a function called on a given contract with a value that is atypical (e.g., input length function call typically in a range of 1-10, and then that function is called with parameters that are outside of the normal range of 1-10, such as called with a range of −1 or 100).

A Relational property can be used to specify a Sequence of events (e.g., A-B-A-B etc.), and/or a Number of events (e.g., number of event A==number of event B, etc.). For example, a baseline behavior determines a normal sequence of events on the blockchain, but if an abnormal sequence of events is monitored, then such can be an indicator of suspicious or malicious activities associated with the blockchain.

A Temporal property (e.g., NFT example) can be used to specify an Order of events (e.g., event A happens *before* event B) and/or a Time range (e.g., event A happened within n blocks). For example, a temporal baseline for transfer of an NFT can be used to detect potentially stolen NFT, such as a transferred NFT is stolen within a threshold period of time (e.g., 30 minutes) after a prior transaction.

A Rule-based property can be used to specify a rule, such as called once (e.g., a given (func) can only be called once), and/or only being called by a specific caller (addr). For example, a rule for a given function that can only be called once can be triggered if the monitored blockchain activities detect that the given function is being called multiple times. As another example if a given function can only be called by a specific caller (addr x), then another rule can be triggered if that given function was called by a different entity (addr y).

Other example properties that can be specified to describe behaviors associated with the blockchain include the following: statistical properties and/or frequency properties.

As will now be apparent to one of ordinary skill in the art, other types of properties can be similarly specified to describe various behaviors associated with the blockchain.

Behaviors of a specific entity can be specified as a combination of variables (e.g., with various properties). In this example implementation, these variables include (without limitation) the following: Tx meta data; Event (log) meta data; Token data; Balance; Contract; and/or other variables can similarly be specified. Each of these variables will now be further described below.

Transaction (Tx) meta data can include an input length (e.g., including parameters associated with the transaction), a count (e.g., how many times the transaction happens, such as per block, per source address, and/or per address across multiple (n) blocks), a log number (e.g., how many logged events were generated), a failed Tx number (e.g., whether the transaction failed or not), a Tx fee (e.g., fee associated with the transaction as each Tx on the block chain typically has a fee, for example, a transaction with atypical logic may be associated with a higher Tx fee), a Nonce (e.g., how many transactions have been initiated from the address to date), and/or a Tx value (e.g., value transferred from a source address to a destination address).

Event (log) meta data can include a Type (e.g., direct or indirect Tx), a Data length (e.g., length of data associated with the Tx), and/or a Count (e.g., how many times has this transaction been performed from the same address, etc.). When transactions on the blockchain are executed, logs are generated and written into the blockchain, which can be used to later examine the transaction (e.g., destination of the transaction, etc.). The event log data can also be deserialized to extract the above-described event (log) meta data that can be performed.

Token data (e.g., for a token type of contract) can include a Price (e.g., price of the transaction for the token), a Volume (e.g., a total supply of the token, such as how many of these tokens have been minted to date), Holders data (e.g., how many entities have this token in their wallets), Transfer data (e.g., number of transfers, origin of transfer, destination (dst) of transfer, etc.), Trading data (e.g., number of trades, trades volume, trades caller, etc.), and/or Market data (e.g., number of markets, type of markets, such as trading one type of token for another token using a swap contract, etc.).

Balance data can include a Balance change and/or a Balance (e.g., balance of native tokens, balance of non-native tokens, etc.).

Contract data can include a Length (e.g., length of the contract) and/or similarity with other contracts (e.g., known benign, known bad, etc.).

Other example variables that can be specified to describe behaviors associated with the blockchain include the following: off-chain data (e.g., including associated hostname/IP/URL, social media account/messages, such as tweets, financial service accounts, and/or any other data/information related on the Internet).

As will now be apparent, blockchain transactions can be monitored/filtered using one or more security platforms to facilitate profiling-based detection for blockchains.

### Example Use Cases of Profiling-Based Detection for Blockchains

The disclosed techniques for profiling-based detection for blockchains can be applied in a variety of additional example use case scenarios for facilitating profiling-based detection for blockchains as will now be described with respect to various example use cases.

As a first example use case, the disclosed techniques can be used to facilitate profiling-based detection for blockchains for the following example of a Qubit hack as described below in Appendix 1.

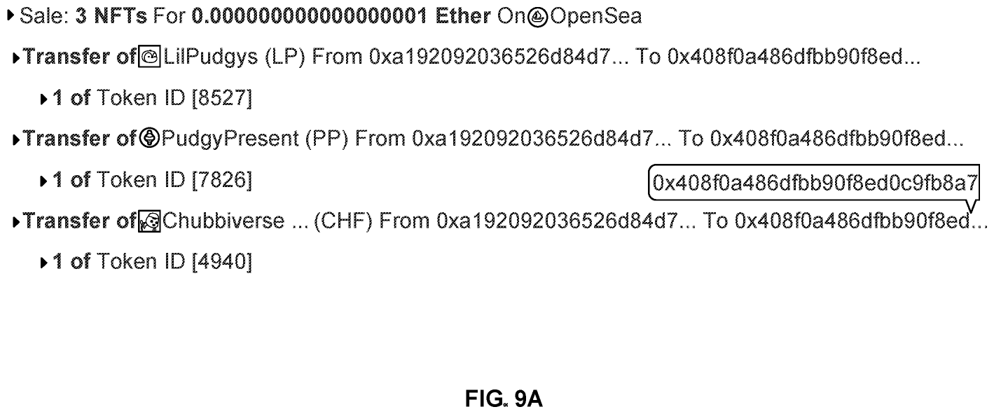

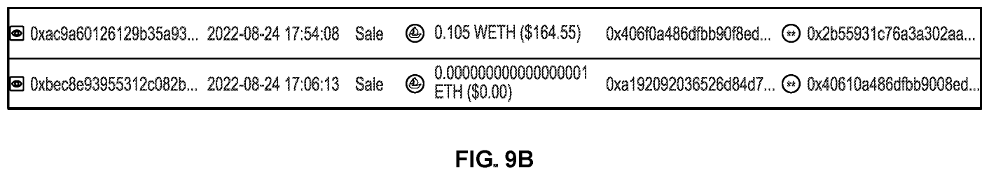

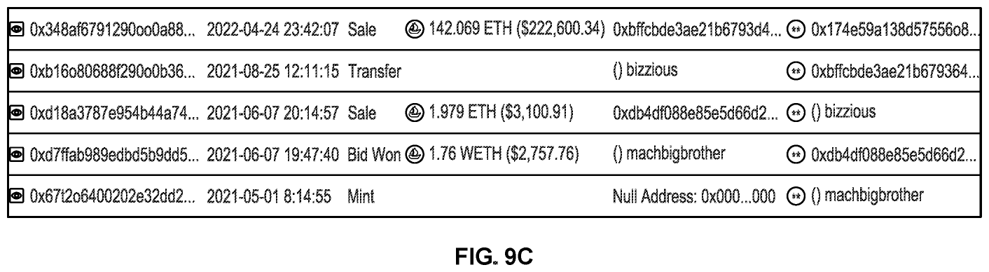

FIGS. 9A-C illustrate an example use case for performing profiling-based detection for blockchains can be used to detect Non-Fungible Token (NFT) phishing related activities based on automatically detecting abnormal behaviors in accordance with some embodiments. In this example use case, the disclosed techniques for profiling-based detection for blockchains can be used to detect Non-Fungible Token (NFT) phishing related activities based on automatically detecting abnormal behaviors. One example is a bulk transfer ownership of multiple NFTs in one Tx (e.g., see https://etherscan.io/tx/0xbec8e93955312c082b3da83eeb8800d1cc8db3096903a82d270c8ed2978 8c0ab) and a sale immediately after transfer of ownership.

As shown in FIG. 9A, a bulk transfer of NFTs is performed.

As shown in FIG. 9B, a subsequent sale of all of these NFTs is performed within one hour after that initial bulk purchase (e.g., see https://etherscan.io/nft/0x42f1654b8eeb80c96471451b1106b63d0b1a9fe1/4940; https://etherscan.io/nft/0x524cab2ec69124574082676e6f654a18df49a048/8527; and https://etherscan.io/nft/0x062e691c2054de82f28008a8ccc6d7alc8ce060d/7826).

As shown in FIG. 9C, a Normal NFT operation is illustrated (e.g., see: https://etherscan.io/nft/0xbc4ca0eda7647a8ab7c2061c2e118a18a936f13d/7294).

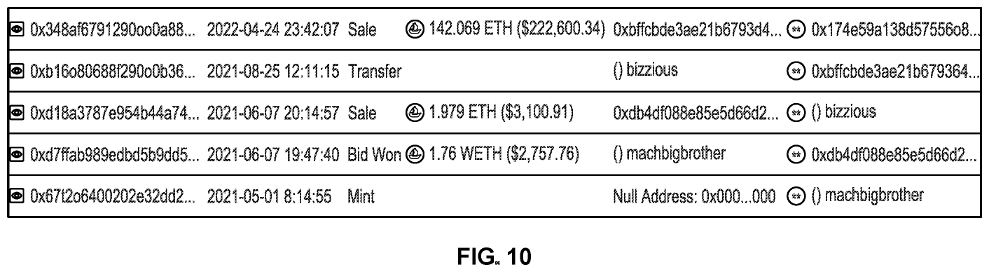

FIG. 10 illustrates an example use case for performing profiling-based detection for blockchains to detect the Omni hack in accordance with some embodiments. In this example use case, the disclosed techniques for profiling-based detection for blockchains can be used to detect the Omni hack. In the Omni hack use case example, the Expected behavior is for a user to stake one NFT, and to borrow some WETH.

The Abnormal behavior is that a user repeatedly stakes the same (e.g., set of) NFTs (e.g., check the “transaction action” under this Tx (e.g., see https://etherscan.io/tx/0x264e16f4862d182a6a0b74977df28a85747b6f237b5e229c9a5bbacdf499 ccb4)).

The Root cause is a code vulnerability (re-entrancy).

In this example use case and as shown in FIG. 10, the disclosed profiling-based detection system can detect this as a malicious transaction based on the Tx's event_count anomaly. Specifically, when the system detects the above attacking Tx, the system can generate an alert. An example alert can be generated as follows (e.g., the “reason” section indicates the trigger for the alert as being a result of the anomalous “event count” (‘event_cnt’) (which is 46 in this Tx), which is a statistical anomaly).

```
{
    “id”: 102,
    “tx”: “0x264e16f4862d182a6a0b74977df28a85747b6f237b5e229c9a5bbacdf499ccb4”,
    “bn”: 15114361,
    “nonce”: 16,
    “to”: “0x3c10e78343c475b99d20fa544dd30b43c0cba26f”,
    “from”: “0x00000000c251faf2de8217ab64accd0070b97e47”,
    “ab_cnt”: 1,
    “ab”: {
      “type”: “event_cnt_in_tx”,
      “target”: “0x218615c78104e16b5f17764d35b905b638fe4a92”,
      “topic0”: “0x8c5be1e5”,
      “reason”: {
        “std_dev”: {
          “std_dev_diff”: 15.90990257669732,
          “new_v”: 46
        }
      }
    },
    “addr”: “0x218615c78104e16b5f17764d35b905b638fe4a92”,
    “ts”: 1657448409,
    “chain”: “ethereum”,
    “msg_id”: 8,
    “topic”: “profile”
  }
```

As a fourth example use case, the disclosed techniques for profiling-based detection for blockchains can be used to detect a privileged operation attack on the blockchain. Generally, the profiling-based detection in this example use case is to monitor and detect access control abnormalities for certain functions (e.g., a privileged function) on a given smart contract that can only be invoked by a predefined addresses (e.g., owner, admin, etc.).

The abnormal behavior is a non-privileged address attempting to invoke such (privileged) functions.

An example is illustrated below.

func “transferOwnership( )” (on this contract) can ONLY be called by “current_owner”, which is addr: (0x73feaalee314f8c655e354234017be2193c9e24e). BUT In this Tx, addr (0x8e837b82ad960f007ad7bceafd09b7fc31d4c976) tried to call “transferOwnership( )”. The tx failed.

As will now be apparent to one of ordinary skill in the art, the disclosed techniques for profiling-based detection for blockchain using a security platform for security policy enforcement can be applied in a variety of additional example use case scenarios to detect/prevent these and other types of attacks for facilitating enhanced security for blockchain.

Additional example processes for the disclosed techniques for profiling-based detection for blockchain will now be described.

### Example Processes for Profiling-Based Detection for Blockchains

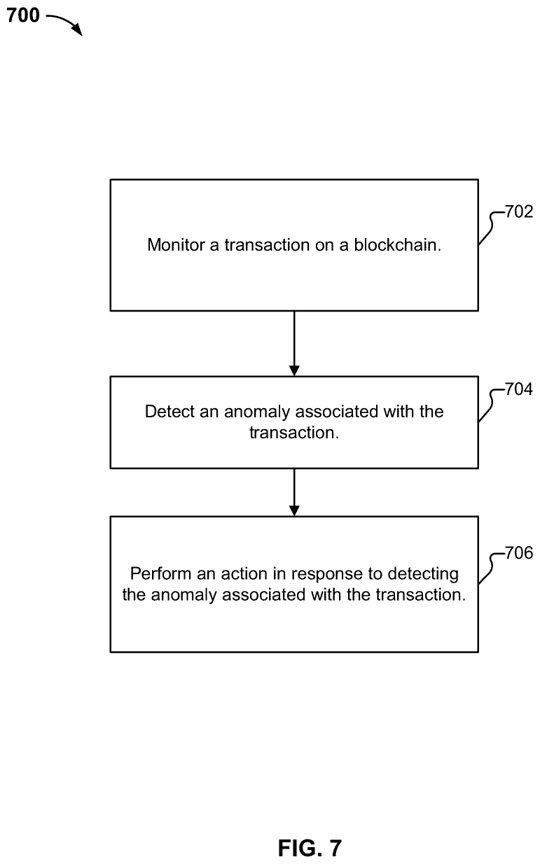

FIG. 7 is a flow diagram of a process for profiling-based detection for blockchains in accordance with some embodiments. In some embodiments, a process 700 as shown in FIG. 7 is performed by the security platform and techniques as similarly described above including the embodiments described above with respect to FIG. 6.

At 702, monitoring a transaction on a blockchain is performed. For example, the profiling-based detection platform for providing security detection for blockchains as similarly described above with respect to FIG. 6 can be used for monitoring a plurality of transactions on the blockchain.

At 704, an anomaly associated with the transaction is detected. For example, the Profiler component of the profiling-based detection platform for providing security detection for blockchains as similarly described above with respect to FIG. 6 can be used for detecting any anomalies associated with each of the plurality of transactions.

At 706, an action is performed in response to detecting the anomaly associated with the transaction. For example, a UI/alerting component of the profiling-based detection platform for providing security detection for blockchains as similarly described above with respect to FIG. 6 can be used for sending an alert in response to detecting the anomaly associated with the transaction.

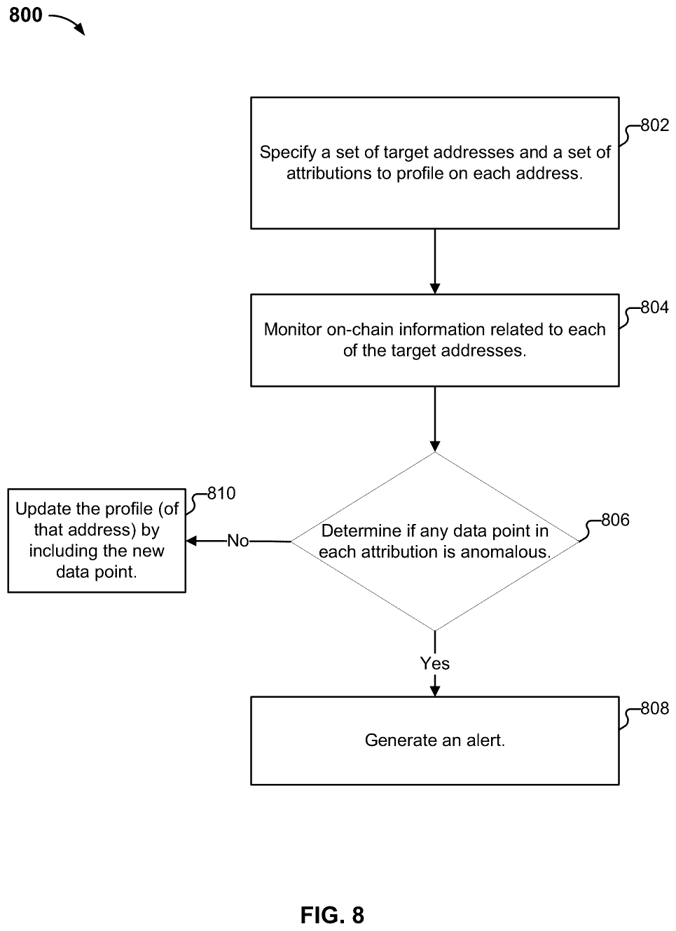

FIG. 8 is another flow diagram of a process for profiling-based detection for blockchains in accordance with some embodiments. In some embodiments, a process 800 as shown in FIG. 8 is performed by the security platform and techniques as similarly described above including the embodiments described above with respect to FIG. 6.

At 802, specifying a set of target addresses and a set of attributions to profile on each address is performed. For example, the profiling-based detection platform for providing security detection for blockchains as similarly described above with respect to FIG. 6 can be used for profiling activities on the blockchain.

At 804, monitoring on-chain information related to each of the target addresses is performed. For example, the profiling-based detection platform for providing security detection for blockchains as similarly described above with respect to FIG. 6 can be used for monitoring a plurality of transactions on the blockchain.

At 806, whether any data point in each attribution is anomalous is performed. For example, the profiler component of the profiling-based detection platform for providing security detection for blockchains can be used for monitoring a plurality of transactions on the blockchain and detecting any anomalies relative to a baseline for such activities on the blockchain, such as similarly described above with respect to FIG. 6.

At 808, an alert is generated in response to the anomaly detection. For example, a UI/alerting component of the profiling-based detection platform for providing security detection for blockchains as similarly described above with respect to FIG. 6 can be used for sending an alert in response to detecting the anomaly associated with the transaction.

At 810, the profile (of that address) is updated based on the new data point. For example, the profiler component of the profiling-based detection platform for providing security detection for blockchains can be continually updated based on the monitoring of a plurality of transactions on the blockchain (e.g., updating a profile for a baseline for such activities on the blockchain), such as similarly described above with respect to FIG. 6.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor of a profiling-based detection platform configured to:
monitor a transaction on a blockchain;
detect an anomaly associated with the transaction using the profiling-based detection platform; and
perform an action in response to detecting the anomaly associated with the transaction; and
a memory coupled to the processor and configured to provide the processor with instructions.

2. The system recited in claim 1, wherein the profiling-based detection platform performs profiling-based detection for the blockchain.

3. The system recited in claim 1, wherein the profiling-based detection platform is configured with a plurality of blockchain security policies.

4. The system recited in claim 1, wherein the transaction on the blockchain includes smart contract transactions.

5. The system recited in claim 1, wherein the processor is further configured to:
detect a malicious transaction on the blockchain.

6. The system recited in claim 1, wherein the processor is further configured to:
detect a malicious transaction on the blockchain based on the anomaly associated with the transaction.

7. The system recited in claim 1, wherein the processor is further configured to:
generate a profile for an address.

8. The system recited in claim 1, wherein the processor is further configured to:
update a profile for an address.

9. The system recited in claim 1, wherein the processor is further configured to:
generate an alert for an anomalous transaction based on a profile.

10. A method, comprising:
monitoring a transaction on a blockchain;
detecting an anomaly associated with the transaction using a profiling-based detection platform; and
performing an action in response to detecting the anomaly associated with the transaction.

11. The method of claim 10, wherein the profiling-based detection platform performs profiling-based detection for the blockchain.

12. The method of claim 10, wherein the profiling-based detection platform is configured with a plurality of blockchain security policies.

13. The method of claim 10, wherein a plurality of transactions are monitored on the blockchain that include smart contract transactions.

14. The method of claim 10, further comprising:
detecting a malicious transaction on the blockchain.

15. The method of claim 10, further comprising:
detecting a malicious transaction on the blockchain based on the anomaly associated with the transaction.

16. The method of claim 10, further comprising:
generating a profile for an address.

17. The method of claim 10, further comprising:
updating a profile for an address.

18. The method of claim 10, further comprising:
generating an alert for an anomalous transaction based on a profile.

19. A computer program product, the computer program product being embodied in a non-transitory computer readable storage medium and comprising computer instructions for:
monitoring a transaction on a blockchain;
detecting an anomaly associated with the transaction using a profiling-based detection platform; and
performing an action in response to detecting the anomaly associated with the transaction.

20. The computer program product recited in claim 19, wherein the profiling-based detection platform performs profiling-based detection for the blockchain.
